(19) United States
(12) Patent Application Publication
(10) Pub. No.: US 2024/0320540 A1
(43) Pub. Date: Sep. 26, 2024

(54) MACHINE LEARNING (ML) BASED SOFTWARE KERNEL SELECTION

(71) Applicant: QUALCOMM Incorporated, San Diego, CA (US)

(72) Inventors: Abhilash Sudhir MARADWAR, Hyderabad (IN); Deepthi SASIDHARA MENON, Hyderabad (IN); Sumit Kumar BHUIN, Ranchi (IN); Ravi GORLA, Hyderabad (IN)

(21) Appl. No.: 18/125,062

(22) Filed: Mar. 22, 2023

(51) Int. Cl. G06N 20/00

(52) U.S. Cl. CPC G06N 20/00

(57) ABSTRACT

Aspects of the disclosure are directed to kernel selection. In accordance with one aspect, disclosed is an apparatus and method for inputting a plurality of valid software kernels to a trained machine learning (ML) model engine; configuring the trained ML model engine to generate a first trained machine learning (ML) model based on the plurality of valid software kernels; and using the first trained ML model to generate a machine learning (ML)-selected software kernel based on the plurality of valid software kernels.

### TECHNICAL FIELD

This disclosure relates generally to the field of machine learning and, in particular, to machine learning based software kernel selection.

### BACKGROUND

A processor, such as a central processing unit (CPU), a graphics processing unit (GPU), a digital signal processor (DSP), an image signal processor (ISP), a network processor (NP), etc., is often the most important component in technological systems to enable a desired function or application. All processors implement a synergistic architecture of hardware and software to maximize performance. A software kernel is one of a multiple of software modules used by a processor to implement a desired function or application. A kernel manager may be part of an operating system or a driver of the processor which is used to select a software kernel for a desired function or application based on specific criteria. Some kernel managers have used criteria based on static optimization parameters for software kernel selection. Improved performance may be attained by exploiting machine learning (ML) for software kernel selection.

### SUMMARY

The following presents a simplified summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides machine learning based software kernel selection. Accordingly, an apparatus for kernel selection, the apparatus including a validation rules engine configured to accept one or more input parameters and a plurality of software kernels, and configured to generate a plurality of valid software kernels based on the input parameters and the plurality of software kernels; and a trained machine learning (ML) model engine coupled to the validation rules engine, the trained ML model engine configured to generate a first trained machine learning (ML) model based on the plurality of valid software kernels.

In one example, the one or more input parameters include one of the following: a plurality of tensors, an attribute of a mathematical operation or function, an attribute of a data or an attribute of a tensor descriptor. In one example, the trained ML model engine is further configured to generate a ML-selected software kernel based on the plurality of valid software kernels by using the first trained ML model.

In one example, the apparatus further includes a training data repository configured to accept an optimal software kernel. In one example, the apparatus further includes a machine learning (ML) model selection engine configured to accept the one or more input parameters and the optimal software kernel from the training data repository.

In one example, the ML model selection engine is further configured to generate a second trained machine learning (ML) model. In one example, the ML model selection engine is further configured to tune the second trained ML model to generate a tuned machine learning (ML) model.

In one example, the apparatus further includes a performance evaluation engine configured to receive the plurality of valid software kernels and further configured to generate a plurality of performance metrics based on the plurality of valid software kernels. In one example, the apparatus further includes a kernel selection engine configured to receive the plurality of performance metrics. In one example, the kernel selection engine is further configured to implement a selection function for each of the plurality of valid software kernels to determine an optimal software kernel.

Another aspect of the disclosure provides a method for kernel selection, the method including inputting a plurality of valid software kernels to a trained machine learning (ML) model engine; configuring the trained ML model engine to generate a first trained machine learning (ML) model based on the plurality of valid software kernels; and using the first trained ML model to generate a machine learning (ML)-selected software kernel based on the plurality of valid software kernels.

In one example, the method further includes inputting one or more input parameters to a validation rules engine. In one example, the method further includes inputting a plurality of software kernels to the validation rules engine. In one example, the method further includes generating the plurality of valid software kernels based on the one or more input parameters and the plurality of software kernels.

In one example, the generating the plurality of valid software kernels is implemented by the validation rules engine. In one example, the one or more input parameters include one of the following: a plurality of tensors, an attribute of a mathematical operation or function, an attribute of a data or an attribute of a tensor descriptor.

In one example, the method further includes providing one or more input parameters and an optimal software kernel to a machine learning (ML) model selection engine from a training data repository. In one example, the method further includes configuring the machine learning (ML) model selection engine to generate a second trained machine learning (ML) model. In one example, the method further includes tuning the second trained ML model by using a training data from the training data repository to generate a tuned machine learning (ML) model.

In one example, the method further includes using the tuned ML model in a kernel selection process in a kernel selection engine based on machine learning (ML). In one example, the method further includes supplying a plurality of performance metrics to the kernel selection engine. In one example, the method further includes configuring the kernel selection engine to implement a selection function for each of the plurality of valid software kernels to determine the optimal software kernel. In one example, the method further includes generating the plurality of performance metrics based on the plurality of valid software kernels.

Another aspect of the disclosure provides an apparatus for kernel selection, the apparatus including means for inputting a plurality of valid software kernels to a trained machine learning (ML) model engine; means for configuring the trained ML model engine to generate a first trained machine learning (ML) model based on the plurality of valid software kernels; and means for using the first trained ML model to generate a machine learning (ML)-selected software kernel based on the plurality of valid software kernels.

In one example, the apparatus further includes means for generating the plurality of valid software kernels based on one or more input parameters and a plurality of software kernels.

In one example, the one or more input parameters include one of the following: a plurality of tensors, an attribute of a mathematical operation or function, an attribute of a data or an attribute of a tensor descriptor. In one example, the apparatus further includes means for generating a second trained machine learning (ML) model. In one example, the apparatus further includes means for tuning the second trained ML model by using a training data from the training data repository to generate a tuned machine learning (ML) model.

Another aspect of the disclosure provides a non-transitory computer-readable medium storing computer executable code, operable on a device including at least one processor and at least one memory coupled to the at least one processor, wherein the at least one processor is configured to implement kernel selection, the computer executable code including instructions for causing a computer to input a plurality of valid software kernels to a trained machine learning (ML) model engine; instructions for causing the computer to configure the trained ML model engine to generate a first trained machine learning (ML) model based on the plurality of valid software kernels; and instructions for causing the computer to use the first trained ML model to generate a machine learning (ML)-selected software kernel based on the plurality of valid software kernels.

In one example, the non-transitory computer-readable medium further includes instructions for causing the computer to generate a second trained machine learning (ML) model and to tune the second trained ML model by using a training data to generate a tuned machine learning (ML) model.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example of channel packing for a tensor.

FIG. 2 illustrates an example for a tensor in NCHW format.

FIG. 3 illustrates an example memory access scenario comparing two different tensor formats.

FIG. 4 illustrates an example tensor access pattern with NCO4HWC4 format.

FIG. 5 illustrates an example performance comparison between two different tensor formats.

FIG. 6 illustrates a first example format used for tensors in software kernels.

FIG. 7 illustrates an example software kernel selection process with static optimization parameters.

FIG. 8 illustrates a second example format used for tensors in software kernels.

FIG. 9 illustrates a first example performance comparison between the two hypothetical software kernels listed in FIG. 8.

FIG. 10 illustrates a second example performance comparison between the two hypothetical software kernels listed in FIG. 8.

FIG. 11 illustrates an example software kernel selection process based on a machine learning (ML) process.

FIG. 12 illustrates an example of an initialization of a machine learning (ML) training phase process.

FIG. 13 illustrates an example of an execution of a machine learning (ML) training phase process.

FIG. 14 illustrates an example flow diagram for a software kernel selection process based on machine learning (ML).

FIG. 15 illustrates an example flow diagram of a training phase of a software kernel selection process based on machine learning (ML).

FIG. 16 illustrates an example flow diagram of a model selection phase of a software kernel selection process based on machine learning (ML).

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein.

For example, those skilled in the art will understand and appreciate that a methodology could alternatively be represented as a series of interrelated states or events, such as in a state diagram. Moreover, not all illustrated acts may be required to implement a methodology in accordance with one or more aspects.

A processor is a programmable digital engine or platform which may be configured to perform a wide variety of useful computing and logical functions in nearly all technological systems. In general, the processor hardware provides the fundamental computational infrastructure for execution of all computing and logical functions. In general, the processor software provides the flexible configuration and control infrastructure for execution of all computing and logical functions using the processor hardware. As system applications increase in sophistication and computational demand, there are continual drivers for improved processor performance in terms of execution speed and processing volume within present-day technological capabilities in dc power demand, storage capacity, communication throughput, networking capability, etc.

One architectural feature of many processors, for example, a graphics processing unit (GPU), is the usage of software kernels to implement a variety of functions and applications. In one example, the software kernels form a library of pre-programmed software modules. For example, many image processing applications require certain mathematical operations such as convolution, cross-correlation, Fourier transformation, filtering, etc. to operate on tensors or data arrays (i.e., a group of data) to generate a desired result. In one example, such mathematical operations may be implemented by a software kernel which is selected from a plurality of software kernels.

In one example, a kernel manager may be part of the operating system or the driver code of the processor which is used to select a software kernel for a desired function or application based on specific criteria. For example, selection of a software kernel from a plurality of software kernels by the kernel manager may be based on static optimization parameters. That is, static optimization parameters, which are predefined values used in a criterion for software kernel selection, may be used as part of a kernel selection algorithm to select a software kernel from the plurality of software kernel based on an optimization criterion. Static optimization parameters may be static bid values which are numerical weights assigned to each software kernel. For example, the static bid values may be based on kernel efficiency for performing certain operations (e.g., processing time for execution of a mathematical operation on a given data array).

In one example, a data array may be represented by a tensor. For example, a tensor is a multi-dimensional array of tensor elements. For example, a tensor element may be a numeric value (e.g., integer or a floating point), a logical (e.g., Boolean) value, a textual (e.g., alphanumeric) value, etc., which is a subset of the tensor.

In one example, a tensor format may be used to describe the arrangement of tensor elements for storage. For example, a buffer/linear format is a tensor format where data is read from a memory sequentially without any extra copy overhead. For example, copy overhead refers to additional undesired processing time due to inefficient memory read/write operations. For example, copy overhead may refer to extra memory read/write operations to copy data from a first buffer to a second buffer to convert from a linear format to an opaque format. In one example, the buffer/linear format may be specified by a NCHW format, where N refers to number of image samples, C refers to image channel, H refers to image height, W refers to image width for the arrangement of tensor elements for storage. In one example, the buffer/linear format may introduce more memory read/write loops (i.e., recurrent operations) which may introduce inefficiency and thus degrade performance. In one example, storage is executed in one or more memory units. In one example, the NCHW format describes axes ordering in a tensor with data samples. For example, the tensor may be described as a composition of N images of C channels of H×W feature maps.

In one example, an opaque format is a tensor format which is optimized to a specific hardware implementation by rearranging tensor elements layout in memory to a specific layout. In one example, the opaque format may specify channel packing and tensor element access ordering (e.g., along width, height or depth dimensions) for memory read/write operations. In one example, the opaque format maintains both spatial and temporal locality. In one example, spatial locality refers to locality of data over memory locations at a particular time. And, in one example, temporal locality refers to locality of data over time at a particular memory location. That is spatial and temporal locality refers to locality of data over memory locations and time simultaneously.

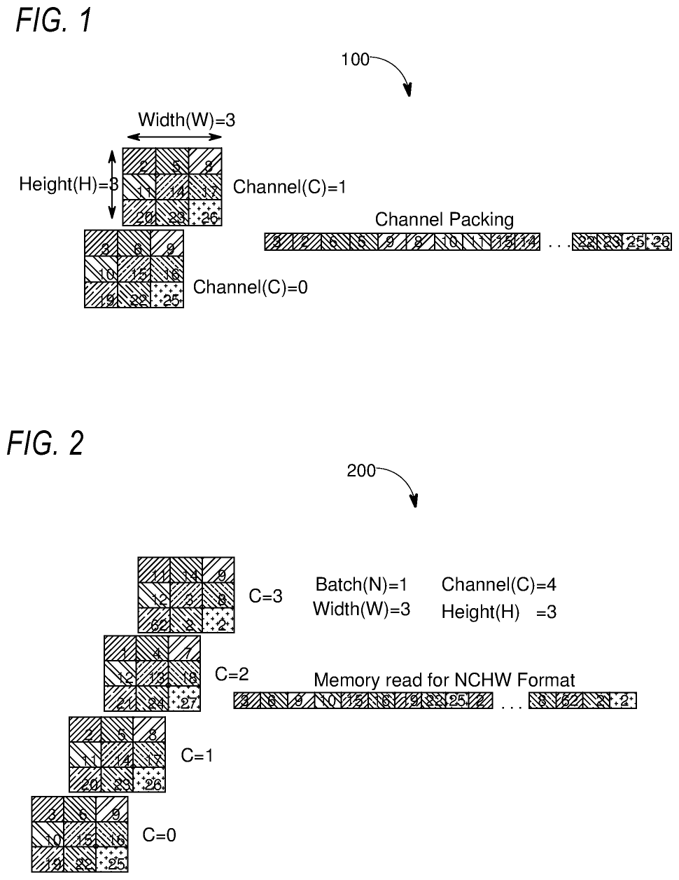

FIG. 1 illustrates an example 100 of channel packing for a tensor. In one example, tensor elements may be read from memory in various orders (e.g., along width or height). In one example, if tensor elements are read from memory along channels, that access technique is known as channel packing. In FIG. 1 tensor elements are accessed along channels (i.e., tensor elements are read with the first element of each channel, then proceeding to a subsequent element along width and then along height. In one example, channel packing means reading all elements of the same width and height from each channel. For example, channel packing may apply to any number of channels.

FIG. 2 illustrates an example 200 for a tensor in NCHW format. In one example, tensor elements may be rearranged in a particular way to minimize cache memory misses and attain improved cache efficiency. For example, conversion from linear format to opaque format improves cache efficiency. In one example, for machine learning (ML), convolutional neural networks (CNNs) may perform image processing on multi-channeled image data. In one example, each channel may represent one color and each pixel may consist of three channels (e.g., a color image may have three channels of red, green and blue (RGB)). In one example, a color image (i.e., an RGB image) may be described as a W×H×C (i.e., width, height, channel) matrix. FIG. 2 illustrates how tensor elements are packed in NCHW format. In one example, for improved efficiency, the opaque format may be utilized where channels are packed or arranged at adjacent positions. For example, channel packing refers to data arrangement in memory.

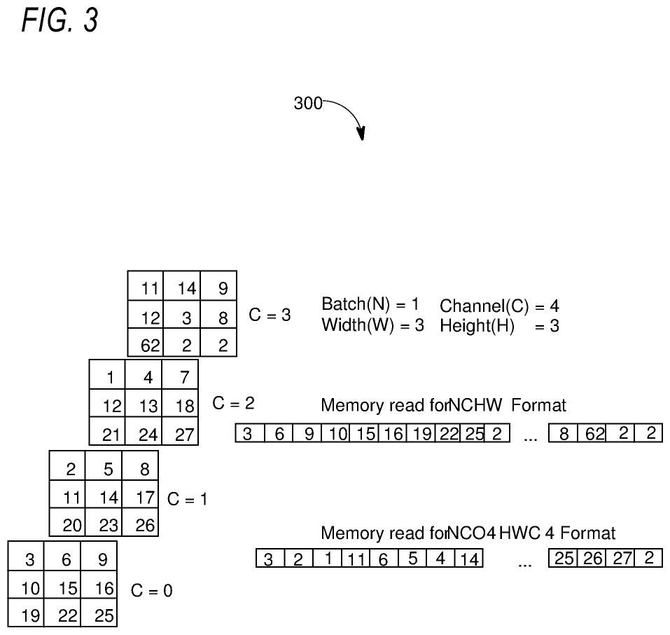

FIG. 3 illustrates an example memory access scenario 300 comparing two different tensor formats. The left side of FIG. 3 shows four channels of a tensor (with batch size N=1) having a height (H) of 3 and a width (W) of 3. In this example, each tensor element is an integer.

The right side of FIG. 3 shows a memory read result for a buffer/linear format (e.g., NCHW format) and a memory read result for an opaque format (e.g., NCO4HWC4 format). For example, FIG. 3 shows that the memory read result for the buffer/linear format is sequential in tensor row order for each channel. For example, FIG. 3 shows that the memory read result for the opaque format is non-sequential in tensor row order and is sequential in channel order.

In one example, for NCO4HWC4 format, C4 denotes 4 channels are packed at one time, CO4 denotes repeating this pattern until all features of 4 channels are exhausted. For example, CO4=0 means that all data from channel 0 to channel 3 are accessed first with four channels packed together and then CO4=1 means all the data from channel 4 to channel 7 are accessed next.

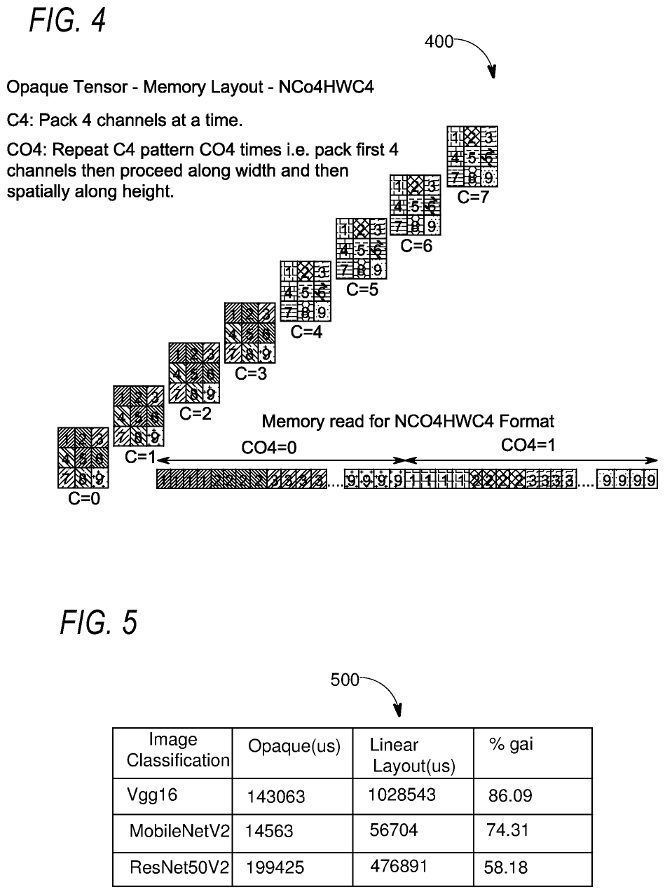

FIG. 4 illustrates an example tensor access pattern 400 with NCO4HWC4 format. For example, the channels are labeled as C=0, C=1, C=2, C=3, C=4, C=5, C=6, C=7. In one example, the first four channels (i.e., C=0, C=1, C=2, C=3) are accessed completely first prior to accessing the next four channels (i.e., C=4, C=5, C=6, C=7).

FIG. 5 illustrates an example performance comparison 500 between two different tensor formats. The first column of FIG. 5 lists three different classification algorithms (e.g., algorithms used to classify objects in an image). The second column and third column of FIG. 5 summarize timing performance metrics (measured in microseconds, s) for opaque format and buffer/linear format, respectively. The fourth column of FIG. 5 lists performance gain, in percent, between the opaque format and buffer/linear format for this example. In one example, performance gain, in percent, is computed as [(linear layout−opaque layout)/linear layout]*100.

In one example, usage of static optimization parameters by the kernel manager, such as static bid values, may not result in optimized performance in some scenarios. For example, in some cases, the static optimization parameters may introduce undesired performance overhead, such as copy overhead, which degrades performance.

In one example, the kernel manager includes a common repository of software kernels for neural network operations which selects one or more software kernels which are capable of executing a desired operation on a target processor. For example, the software kernels may be compiled using a software compiler, and metadata may be generated which is part of corresponding software drivers. For example, the software drivers may act as clients to the kernel manager to retrieve the selected software kernel, associated metadata and other information. In one example, if more than one software kernel supports the desired operation based on a set of inputs and weight criteria, the selection decision to select one software kernel from a plurality of software kernels may be based on static optimization parameters such as static bid values.

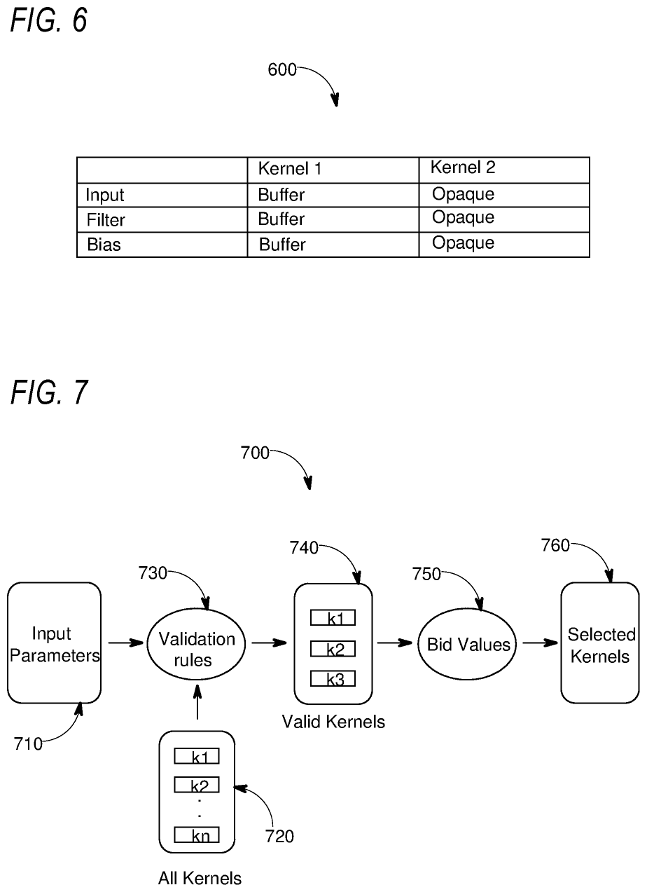

FIG. 6 illustrates a first example format 600 used for tensors in software kernels. In this example, three tensors (i.e., data arrays) are listed in the first column: an input tensor, a filter tensor, and a bias tensor are listed as part of a particular mathematical operation known as convolution. In one example, convolution performs a linear superposition of the input tensor and the filter tensor to generate a convolved tensor. In one example, as an optional step, the convolved tensor may be added to a bias tensor to produce an output tensor. For example, convolution is a common digital signal processing operation used to mathematically represent the effect of filtering on a two-dimensional array of values (e.g., image data).

In FIG. 6, tensor format properties for two hypothetical software kernels for a desired application, Kernel 1 and Kernel 2, are shown in the second column and third column, respectively. For example, Kernel 1 is shown as having a buffer/linear format for the input tensor, the filter tensor and the bias tensor. For example, Kernel 2 is shown as having an opaque format for the input tensor and the filter tensor and a buffer/linear format for the bias tensor. In one example, a kernel manager may assign a static bid value (e.g., on a scale of 1 to 100) to Kernel 2 which is higher than a static bid value for Kernel 1, since it has greater usage of the opaque format which may have faster memory read accesses and perhaps better performance. In one example, the kernel manager may determine that both hypothetical software kernels are suitable for the desired application and may select Kernel 2 due to its higher static bid value compared to the static bid value of Kernel 1. That is, selection of a software kernel from a plurality of software kernels by the kernel manager may be based on static optimization parameters.

FIG. 7 illustrates an example software kernel selection process 700 with static optimization parameters. For example, input parameters 710 are supplied at the start of the process to a validation rules engine 730. For example, a plurality of software kernels 720 (labeled k1, k2, k3, . . . , kn in FIG. 7) which is capable of implementing a desired application, are supplied to the validation rules engine 730. For example, based on the input parameters 710 and the plurality of software kernels 720, the validation rules engine 730 produces a plurality of valid software kernels 740 (labeled k1, k2, k3 in FIG. 7) which is a subset of the plurality of software kernels 720.

In one example, the plurality of valid software kernels 740 is produced based on a plurality of validation rules which determines which software kernels of the plurality of software kernels 720 are capable of implementing the desired application. For example, the plurality of validation rules determines all software kernels which can support a desired mathematical operation. In one example, the plurality of valid software kernels 740 are delivered to a bid values engine 750. For example, the bid values engine 750 determines a plurality of static bid values associated with the plurality of valid software kernels 740.

In one example, the plurality of static bid values may be based on kernel efficiency for performing certain operations (e.g., processing time for execution of a mathematical operation on a given data array). In one example, the bid values engine 750 produces a selected static software kernel 760 from the plurality of valid software kernels 740 based on the plurality of static bid values. For example, the selected static software kernel 760 may have a static bid value which is higher than static bid values of all other valid software kernels. That is, the selected static software kernel 760 has the highest ranking of the software kernels from the plurality of valid software kernels 740. In one example, the selected static software kernel 760 may be a plurality of selected software kernels with the same static bid value.

In one example, the input parameters 710 may be attributes of a ML operation, a software kernel or of a mathematical operation. For example, the input parameters may include a plurality of tensors (i.e., data arrays), attributes of a mathematical operation or function, attributes of data, attributes of a tensor descriptor, etc.

In one example, the selected software kernel determined by the software kernel selection process 700 with static optimization parameters may not be the highest performing software kernel from the plurality of software kernels. For example, the selected static software kernel 760 may introduce additional processing overhead, such as copy overhead. That is, processor performance (e.g., GPU performance) may be altered by the selected software kernel selection process 700 with static optimization parameters. For example, format conversions from buffer/linear format to opaque format may introduce copy overhead. For example, copy overhead in opaque format may be due to an additional copy kernel which converts from buffer/linear format to opaque format.

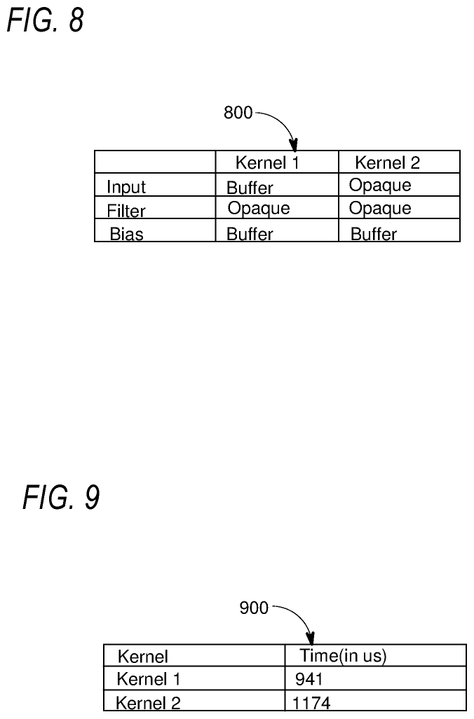

FIG. 8 illustrates a second example format 800 used for tensors in software kernels. In this example, an input tensor is denoted as [1, 128, 88, 88] in NCHW format, a filter tensor is denoted as [128, 128, 1, 1] in NCHW format, and a bias tensor is denoted as [1, 128, 1, 1] in NCHW format. The first column of FIG. 8 lists three tensors (i.e., data arrays): an input tensor, a filter tensor, and a bias tensor as part of a convolution operation. Tensor format properties for two hypothetical software kernels for a desired application, Kernel 1 and Kernel 2, are shown in the second column and third column, respectively.

For example, Kernel 1 is shown as having a buffer/linear format for the input tensor and the bias tensor and an opaque format for the filter tensor. For example, Kernel 2 is shown as having an opaque format for the input tensor and the filter tensor and a buffer/linear format for the bias tensor. In one example, a kernel manager may assign a static bid value (e.g., on a scale of 1 to 100) to Kernel 2 which is higher than a static bid value for Kernel 1, since it has greater usage of the opaque format which may have faster memory read accesses and perhaps better performance. In one example, the kernel manager may determine that both hypothetical software kernels are suitable for the desired application and may select Kernel 2 due to its higher static bid value compared to the static bid value of Kernel 1. That is, selection of a software kernel from a plurality of software kernels by the kernel manager may be based on static optimization parameters.

FIG. 9 illustrates a first example performance comparison 900 between the two hypothetical software kernels listed in FIG. 8 which are used in a single layer for convolution. The first column of FIG. 9 lists the two hypothetical software kernels of FIG. 8, Kernel1 and Kernel2.

The second column of FIG. 9 summarizes timing performance metrics (measured in microseconds, s) of the two software kernels of FIG. 8, Kernel1 and Kernel2. In this example, Kernel 1 has better timing performance than Kernel2 (i.e., 1241 μs vs. 1174 μs). That is, in this example, selection of a software kernel which is based on static optimization parameters, yields a non-optimal selection in terms of timing performance. In one example, a layer is equivalent to a processing stage in a sequence of processing stages. For example, a layer may be a single operation (e.g., convolution) which is executed at an atomic level.

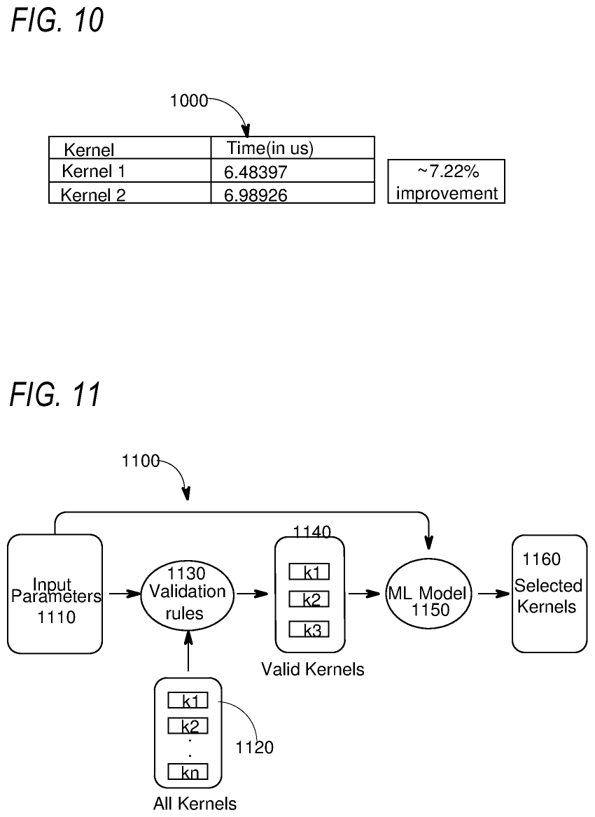

FIG. 10 illustrates a second performance comparison 1000 between the two hypothetical software kernels listed in FIG. 8 which are used in multiple layers for convolution. The first column of FIG. 10 lists the two hypothetical software kernels, Kernel1 and Kernel2. The second column of FIG. 10 summarizes timing performance metrics (measured in microseconds, s) of the two hypothetical software kernels, Kernel1 and Kernel2. In this example, Kernel1 has better timing performance than Kernel2 (i.e., 6.483 ms vs. 6.989 ms); that is, an improvement of 7.22%.

In one example, there may be additional copy overhead when using Kernel2 compared to Kernel1 due to the input tensor having an opaque format for Kernel2 vs. having a buffer/linear format for Kernel1 (i.e., there is an extra conversion step required for the opaque format).

In one example, for other scenarios, which may have multiple layers for convolution, there may be cases where a plurality of software kernels is valid. For example, selection of a software kernel based on static optimization parameters (e.g., with the highest static bid value) may yield a non-optimal selection in terms of timing performance. That is, optimal selection (i.e., yielding better performance) of a software kernel from a plurality of software kernels may be based on a different criterion than using static optimization parameters (e.g., static bid values).

In one example, usage of machine learning (ML) for software kernel selection may result in better performances, and in some cases, result in significantly improved performance. For example, machine learning may be a ML software program which generates a trained ML model which is based on, or trained, by a training set.

In one example, the training set is a set of input data and output data, available a priori, related by an unknown functional mapping between the input data and the output data. The training set may be used to generate the trained ML model which represents or approximates the unknown functional mapping between the input data and the output data. In one example, a ML training phase is an initial phase where the training set is supplied to the ML software program to generate the trained ML model according to a training algorithm.

In one example, a low-level application programming interface (API) may be used for machine learning, such as DirectML. For example, the low-level API may be used to implement various functions such as upscaling, anti-aliasing, style transfer, etc. For example, the low-level API may be used in applications such as robotics, face detection, object counting, activity recognition, etc.

For example, a ML recurring phase is an operational phase where the trained ML model is subsequently used to estimate or predict output data given an arbitrary input data. That is, in one example, the purpose of ML is to use machine intelligence to discover data patterns and functional relationships between input data and output data of the training set to produce the trained ML model. In one example, the trained ML model may be used to estimate or predict output data for any arbitrary input data, particularly input data not in the training set. In one example, the recurring phase is also known as an inference phase.

In one example, a machine learning process may be used to provide a trained ML model, evolved from a training set, to select a ML-selected software kernel from a plurality of software kernels, based on a different criterion than using static optimization parameters (e.g., static bid values). In one example, the ML-selected software kernel may have better performance (e.g., better timing performance) than the selected software kernel from the software kernel selection process 700 with static optimization parameters.

In one example, the machine learning process may employ a validation rules engine which produces a plurality of valid software kernels based on a plurality of validation rules and determines valid software kernels of the plurality of software kernels which are capable of implementing the desired application. In one example, the plurality of validation rules determines all software kernels which may support a desired mathematical operation. For example, the machine learning process may select the ML-selected software kernel based on the trained ML model instead of the static optimization parameters (e.g., static bid values).

In one example, the machine learning process may employ an Open Neural Network Exchange (ONNX) software utility package for interoperable ML model development, and algorithms and tools for artificial intelligence (AI) applications. For example, ONNX may include utilities to develop training algorithms for use in training ML models.

FIG. 11 illustrates an example software kernel selection process 1100 based on a machine learning (ML) process. In one example, input parameters 1110 are supplied at the start of the process to a validation rules engine 1130. For example, a plurality of software kernels 1120 (labeled k1, k2, k3, . . . , kn in FIG. 11), capable of implementing a desired application, is supplied to the validation rules engine 1130. For example, based on the input parameters 1110 and the plurality of software kernels 1120, the validation rules engine 1130 produces a plurality of valid software kernels 1140 (labeled k1, k2, k3 in FIG. 11) where each valid software kernel is a subset of the plurality of software kernels 1120.

In one example, the plurality of valid software kernels 1140 is produced based on a plurality of validation rules which determines which software kernels of the plurality of software kernels 1120 are capable of implementing the desired application. For example, the plurality of validation rules determines all software kernels which can support a desired mathematical operation. In one example, the plurality of valid software kernels 1140 is delivered to a trained ML model engine 1150. For example, the trained ML model engine 1150 includes a trained ML model associated with the plurality of valid software kernels 1140. In one example, the trained ML model engine 1150 may also use the input parameters 1110.

In one example, the trained ML model may be based on kernel efficiency for performing certain operations (e.g., processing time for execution of a mathematical operation on a given data array). In one example, the trained ML model engine 1150 produces a ML-selected software kernel 1160 from the plurality of valid software kernels 1140 based on the trained ML model as part of the ML recurring phase. In one example, the trained ML model is generated by a training algorithm using a training set. In one example, the ML-selected software kernel 1160 is based on a different criterion than using static optimization parameters (e.g., static bid values). In one example, the trained ML model engine 1150 predicts a best performing software kernel based on the input parameters 1110. In one example, for the recurring phase or inference phase, the example software kernel selection process 1100 requires the input parameters 1110 (e.g., input parameters of actual tests for inference), the plurality of valid kernels 1140 and the trained ML model engine 1150.

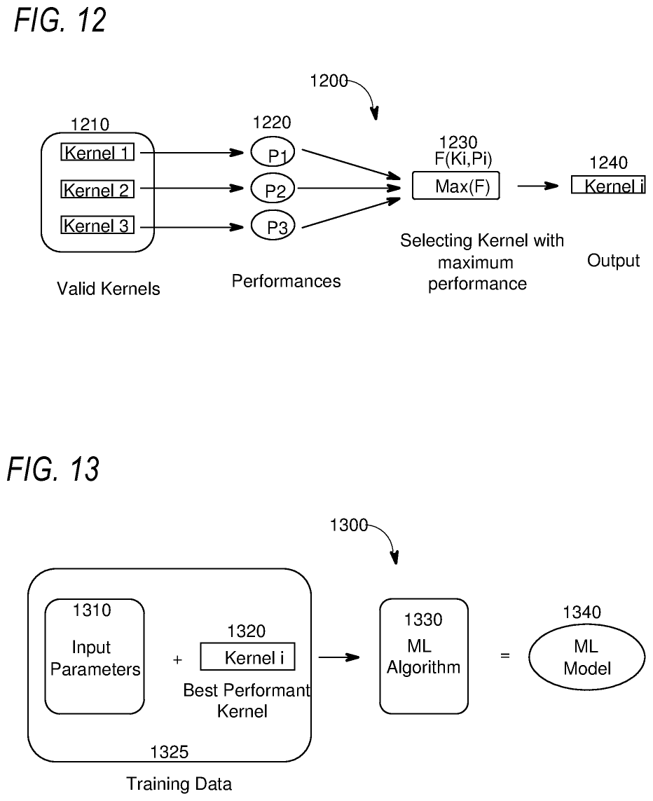

FIG. 12 illustrates an example of an initialization of a machine learning (ML) training phase process 1200. In one example, the ML training phase process supplies a training set used to generate the trained ML model according to a training algorithm. In one example, the training algorithm is part of a ML software program. In one example, the ML training phase process is executed offline, that is, a priori to the ML recurring phase.

In one example, a plurality of valid software kernels 1210 (e.g., Kernel 1, Kernel 2, Kernel 3 in FIG. 12) is supplied to a performance evaluation engine 1220 to generate a plurality of performance metrics (e.g., P1, P2, P3). For example, the plurality of valid software kernels 1210 is part of the training set used to generate the trained ML model. In one example, the plurality of performance metrics is associated with the plurality of valid software kernels 1210. In one example, the performance metric P1 is associated with Kernel 1, the performance metric P2 is associated with Kernel 2, and the performance metric P3 is associated with Kernel 3, etc.

In one example, the plurality of performance metrics is supplied to a kernel selection engine 1230 to provide a selected software kernel Kmax 1240. For example, the kernel selection engine 1230 may implement a selection function F(Ki, Pi) for all valid software kernels Ki, indexed by integer i, and for all performance metrics Pi, indexed by integer i, to provide the selected software kernel Kmax 1240. In one example, the selected software kernel Kmax 1240 has the maximum performance Pmax=MAX{Pi}, where MAX denotes a maximum operator (i.e., MAX{Pi} is the maximum of the set {Pi}). In one example, the selected software kernel Kmax 1240 is part of the training set used to generate the trained ML model according to the training algorithm.

In one example, the training algorithm uses a plurality of input parameters and the selected software kernel Kmax 1240 as the training set. In one example, the training set and the training algorithm are used to generate the trained ML model. In one example, the training algorithm may employ supervised learning, a process which estimates or predicts output data given an arbitrary input data. The training algorithm may use machine intelligence to discover data patterns and functional relationships between input data and output data of the training set to produce the trained ML model. In one example, the trained ML model may be used to estimate or predict output data for any arbitrary input data, particularly input data not in the training set.

In one example, the training algorithm is a multiclass classification algorithm. For example, the training algorithm may employ one of a plurality of candidate ML models such as decision tree, random forest, K nearest neighbor, linear regression, etc.

In one example, the decision tree model uses a tree structure with a hierarchy of tree nodes to make decisions. In one example, the random forest model uses decision trees on multiple samples and uses a majority vote to make decisions. In one example, the K nearest neighbor model uses a proximity algorithm to make decisions.

FIG. 13 illustrates an example of an execution 1300 of a machine learning (ML) training phase process. In one example, the ML training phase process supplies a training set used to generate the trained ML model according to a training algorithm. For example, the training algorithm may be part of a ML software program. In one example, the ML training phase process is executed offline, that is, a priori to the ML recurring phase.

In one example, input parameters 1310 and an optimal software kernel Kopt 1320 are combined to form an aggregate training set residing within a training data repository 1325. In one example, the input parameters 1310 and the optimal software kernel Kopt 1320 are determined a priori to the ML recurring phase. In one example, the optimal software kernel Kopt 1320 is identical to the selected software kernel Kmax 1240 from FIG. 12. For example, the aggregate training set (residing within a training data repository 1325) may be supplied to a ML training algorithm (which runs on a ML model selection engine 1330) to determine a trained ML model 1340. In one example, the trained ML model 1340 may be tuned by using additional training data and a plurality of candidate ML models to produce a tuned ML model (not shown). In one example, a candidate ML model may be one of the following: a decision tree, a random forest, a K nearest neighbor, etc. In one example, a candidate ML model is a ML model that could be used to produce a tuned ML model. In one example, for the training phase, the example software kernel selection process 1300 requires the input parameters 1310 (e.g., input parameters for training data) and the optimal software kernel Kopt 1320. In one example, the input parameters 1310 used for the training phase are the same as the input parameters 1110 used for the recurring phase or inference phase, but data used for the two phases are different.

In one example, subsequent to the ML training phase, in the ML recurring phase, either the trained ML model 1340 or the tuned ML model may be used in the trained ML model engine 1150 of FIG. 11 to produce a ML-selected software kernel 1160. In one example, the plurality of valid software kernels 1140 serves as an input to the trained ML model engine 1150 of FIG. 11.

In one example, wherein the ML training phase occurs offline, ML training does not have a dc power impact. during the ML recurring phase. In one example, the ML recurring phase may result in performance improvement in terms of execution speed and processing volume.

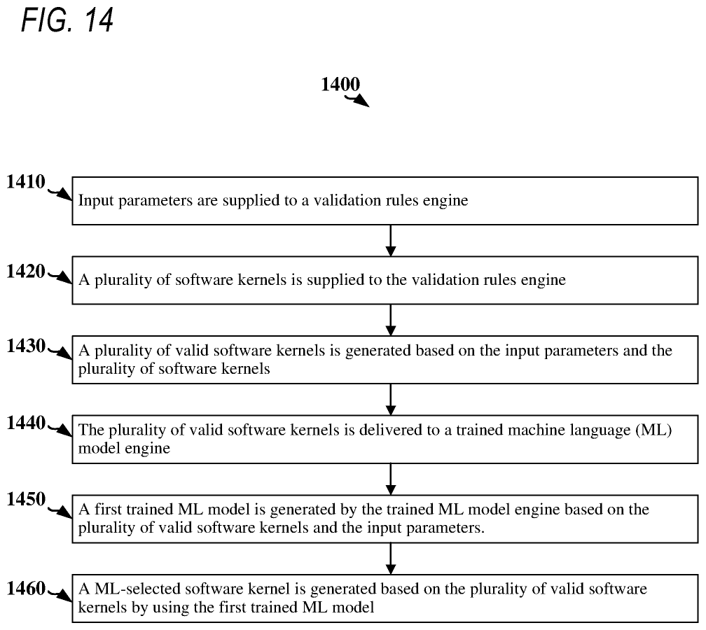

FIG. 14 illustrates an example flow diagram 1400 for a software kernel selection process based on machine learning (ML). In block 1410, input parameters are supplied to a validation rules engine; that is, the input parameters are inputted to the validation rules engine. For example, the input parameters may be attributes of a software kernel or of a mathematical operation. In one example, the input parameters may include a plurality of tensors (i.e., data arrays), attributes of a mathematical operation or function, attributes of a data, attributes of a tensor descriptor, etc. In one example, an attribute may be a name or label, a dimension, a data type, etc.

In block 1420, a plurality of software kernels is supplied to the validation rules engine; that is, the plurality of software kernels is inputted to the validation rules engine. For example, the plurality of software kernels may be a library of pre-programmed software modules which implement a variety of functions and applications. For example, the plurality of software kernels may include mathematical operations such as convolution, cross-correlation, Fourier transformation, filtering, etc. to operate on data arrays or tensors.

In block 1430, a plurality of valid software kernels is generated based on the input parameters and the plurality of software kernels. In one example, the plurality of valid software kernels is generated by the validation rules engine. In one example, the plurality of valid software kernels is based on a plurality of validation rules which determines which software kernels of the plurality of software kernels are capable of implementing the desired application. In one example, the plurality of validation rules determines all software kernels which may support a desired mathematical operation.

In one example, the validation rules engine is the same as the validation rules engine 730 of FIG. 7. In one example, the plurality of software kernels is the same as the plurality of software kernels 720 of FIG. 7. In one example, the plurality of valid software kernels is the same as the plurality of valid software kernels 740 which are labeled k1, k2, k3 in FIG. 7).

In one example, the validation rules engine 730 (of FIG. 7) generates the plurality of valid software kernels (e.g., the plurality of valid software kernels 740 which are labeled k1, k2, k3 in FIG. 7). And, in one example, the plurality of valid software kernels is a subset of the plurality of software kernels 720 of FIG. 7.

In block 1440, the plurality of valid software kernels is delivered to a trained machine learning (ML) model engine; that is, the plurality of valid software kernels is inputted to the trained machine learning (ML) model engine. In one example, the trained ML model engine utilizes a first trained ML model which is based on, or trained by, a training set. In one example, the training set is a set of input data and output data, available a priori, which are related by an unknown functional mapping between the input data and the output data. For example, the training set may be used to generate the first trained ML model which represents or approximates the unknown functional mapping between the input data and the output data.

In block 1450, a first trained ML model is generated by the trained ML model engine based on the plurality of valid software kernels and the input parameters. In one example, the trained ML model engine is configured to generate the first trained ML model. For example, the first trained ML model is generated according to a training algorithm. In one example, the first trained ML model is the trained ML model 1150 of FIG. 11.

In block 1460, a ML-selected software kernel is generated based on the plurality of valid software kernels by using the first trained ML model. In one example, the ML-selected software kernel may be tuned by using additional training data and a plurality of candidate ML models such as decision tree, random forest, K nearest neighbor, etc., to produce a tuned ML-selected software kernel. In one example, the decision tree model uses a tree structure with a hierarchy of tree nodes to make decisions. In one example, the random forest model uses decision trees on multiple samples and uses a majority vote to make decisions. In one example, the K nearest neighbor model uses a proximity algorithm to make decisions.

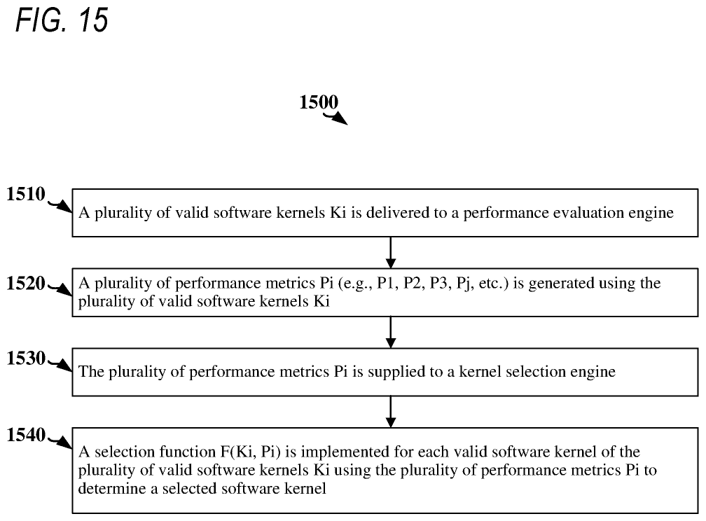

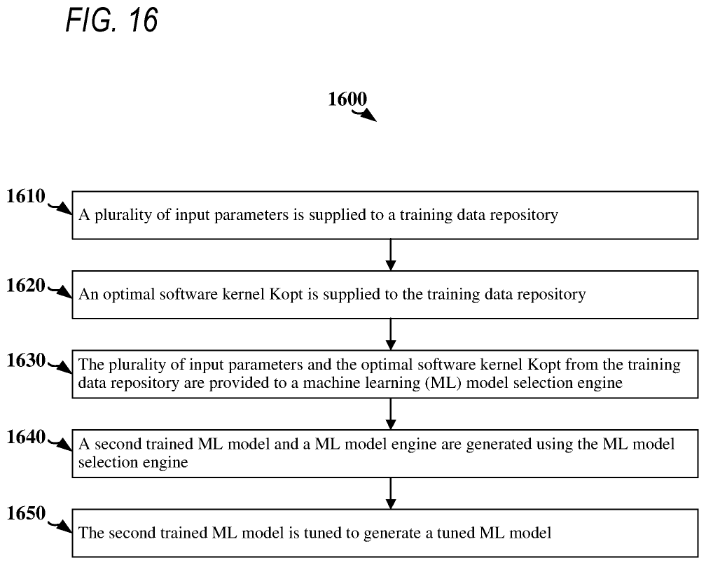

FIG. 15 illustrates an example flow diagram 1500 of a training phase of a software kernel selection process based on machine learning (ML). In block 1510, a plurality of valid software kernels Ki is delivered to a performance evaluation engine (e.g., performance evaluation engine 1220 of FIG. 12). In one example, the plurality of valid software kernels Ki is part of the training set used to generate a trained ML model. For example, the plurality of valid software kernels Ki may be indexed by integer i. In one example, the trained ML model is the first trained ML model of FIG. 14. In one example, the trained ML model is the second trained ML model of FIG. 16.

In block 1520, a plurality of performance metrics Pi (e.g., P1, P2, P3, Pj, etc.) is generated using the plurality of valid software kernels Ki. In one example, the plurality of performance metrics Pi is generated by the performance evaluation engine (e.g., performance evaluation engine 1220 of FIG. 12). For example, the plurality of performance metrics Pi may be associated with the plurality of valid software kernels Ki. In one example, a performance metric P1 is associated with Kernel 1, a performance metric P2 is associated with Kernel 2, a performance metric P3 is associated with Kernel 3, and a performance metric Pj is associated with Kernel j, etc. In one example, the plurality of performance metrics Pi is indexed by integer i.

In block 1530, the plurality of performance metrics Pi is supplied to a kernel selection engine (e.g., the kernel selection engine 1230 of FIG. 12). In one example, the plurality of performance metrics Pi are numerical values which measure timing performance or processing volume performance of the plurality of valid software kernels Ki.

In block 1540, a selection function F(Ki, Pi) is implemented for each valid software kernel of the plurality of valid software kernels Ki using the plurality of performance metrics Pi to determine a selected software kernel (e.g., the selected software kernel Kmax 1240 of FIG. 12). For example, the selected software kernel Kmax 1240 has the maximum performance Pmax=MAX{Pi}, where MAX denotes a maximum operator (i.e., MAX{Pi} is the maximum of the set {Pi}). In one example, the selected software kernel Kmax 1240 is part of a training set used to generate a trained ML model according to a training algorithm. In one example, the selected software kernel is the optimal software kernel Kopt 1320 of FIG. 13. In one example, the trained ML model is the first trained ML model of FIG. 14. In one example, the trained ML model is the second trained ML model of FIG. 16.

FIG. 16 illustrates an example flow diagram 1600 of a model selection phase of a software kernel selection process based on machine learning (ML). In block 1610, a plurality of input parameters is supplied to a training data repository; that is the plurality of input parameters is inputted to the training data repository. In one example, the plurality of input parameters may be attributes of a software kernel or of a mathematical operation. For example, the plurality of input parameters may include a plurality of tensors (i.e., data arrays), attributes of a mathematical operation or function, attributes of data, attributes of a tensor descriptor, etc.

In block 1620, an optimal software kernel Kopt is supplied to the training data repository; that is, the optimal software kernel Kopt is inputted to the training data repository. In one example, the optimal software kernel Kopt is a selected software kernel Kmax from a training phase for a software kernel selection process based on machine learning (ML).

In block 1630, the plurality of input parameters and the optimal software kernel Kopt from the training data repository are provided to a machine learning (ML) model selection engine. In one example, the ML model selection engine employs a ML algorithm. For example, the ML algorithm may be based on a decision tree algorithm, a random forest algorithm, a K nearest neighbor algorithm, etc. In one example, the decision tree algorithm uses a tree structure with a hierarchy of tree nodes to make decisions. In one example, the random forest algorithm uses decision trees on multiple samples and uses a majority vote to make decisions.

In one example, the K nearest neighbor algorithm uses a proximity algorithm to make decisions.

In block 1640, a second trained ML model and a ML model engine are generated using the ML model selection engine. In one example, the second trained ML model is based on, or trained by, a training set. For example, the training set may be an input data and an output data related by a functional mapping between the input data and the output data. For example, the training set may be used to generate the second trained ML model which represents or approximates the functional mapping between the input data and the output data. In one example, the ML model selection engine uses a training algorithm. In one example, the functional mapping is unknown a priori. In one example, the first trained ML model disclosed in FIG. 14 is different from the second trained ML model disclosed in FIG. 16. In one example, the second trained ML model may be used in a software kernel selection process based on machine learning (ML). In one example, the first trained ML model and the second trained ML model are identical. In another example, the first trained ML model and the second trained ML model are different.

In block 1650, the second trained ML model is tuned to generate a tuned ML model. In one example, the ML model selection engine tunes the second trained ML model to generate the tuned ML model. For example, the second trained ML model may be tuned by using additional training data and a plurality of candidate ML models such as decision tree, random forest, K nearest neighbor, etc. to generate a tuned ML model. In one example, the tuned ML model may be used in a software kernel selection process based on machine learning (ML).

In one aspect, one or more of the steps in FIGS. 14, 15 and/or 16 may be executed by one or more processors which may include hardware, software, firmware, etc. The one or more processors, for example, may be used to execute software or firmware needed to perform the steps in the flow diagram(s) of FIGS. 14, 15 and/or 16. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. The terms “circuit” and “circuitry” (if used) are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged.

The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims.

Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus for kernel selection, the apparatus comprising:
a validation rules engine configured to accept one or more input parameters and a plurality of software kernels, and configured to generate a plurality of valid software kernels based on the input parameters and the plurality of software kernels; and
a trained machine learning (ML) model engine coupled to the validation rules engine, the trained ML model engine configured to generate a first trained machine learning (ML) model based on the plurality of valid software kernels.

2. The apparatus of claim 1, wherein the one or more input parameters include one of the following: a plurality of tensors, an attribute of a mathematical operation or function, an attribute of a data or an attribute of a tensor descriptor.

3. The apparatus of claim 1, wherein the trained ML model engine is further configured to generate a ML-selected software kernel based on the plurality of valid software kernels by using the first trained ML model.

4. The apparatus of claim 3, further comprising a training data repository configured to accept an optimal software kernel.

5. The apparatus of claim 4, further comprising a machine learning (ML) model selection engine configured to accept the one or more input parameters and the optimal software kernel from the training data repository.

6. The apparatus of claim 5, wherein the ML model selection engine is further configured to generate a second trained machine learning (ML) model.

7. The apparatus of claim 6, wherein the ML model selection engine is further configured to tune the second trained ML model to generate a tuned machine learning (ML) model.

8. The apparatus of claim 1, further comprising a performance evaluation engine configured to receive the plurality of valid software kernels and further configured to generate a plurality of performance metrics based on the plurality of valid software kernels.

9. The apparatus of claim 8, further comprising a kernel selection engine configured to receive the plurality of performance metrics.

10. The apparatus of claim 9 wherein the kernel selection engine is further configured to implement a selection function for each of the plurality of valid software kernels to determine an optimal software kernel.

11. A method for kernel selection, the method comprising:
inputting a plurality of valid software kernels to a trained machine learning (ML) model engine;
configuring the trained ML model engine to generate a first trained machine learning (ML) model based on the plurality of valid software kernels; and
using the first trained ML model to generate a machine learning (ML)-selected software kernel based on the plurality of valid software kernels.

12. The method of claim 11, further comprising inputting one or more input parameters to a validation rules engine.

13. The method of claim 12, further comprising inputting a plurality of software kernels to the validation rules engine.

14. The method of claim 13, further comprising generating the plurality of valid software kernels based on the one or more input parameters and the plurality of software kernels.

15. The method of claim 14, wherein the generating the plurality of valid software kernels is implemented by the validation rules engine.

16. The method of claim 14, wherein the one or more input parameters include one of the following: a plurality of tensors, an attribute of a mathematical operation or function, an attribute of a data or an attribute of a tensor descriptor.

17. The method of claim 11, further comprising providing one or more input parameters and an optimal software kernel to a machine learning (ML) model selection engine from a training data repository.

18. The method of claim 17, further comprising configuring the machine learning (ML) model selection engine to generate a second trained machine learning (ML) model.

19. The method of claim 18, further comprising tuning the second trained ML model by using a training data from the training data repository to generate a tuned machine learning (ML) model.

20. The method of claim 19 further comprising using the tuned ML model in a kernel selection process in a kernel selection engine based on machine learning (ML).

21. The method of claim 20, further comprising supplying a plurality of performance metrics to the kernel selection engine.

22. The method of claim 21, further comprising configuring the kernel selection engine to implement a selection function for each of the plurality of valid software kernels to determine the optimal software kernel.

23. The method of claim 21, further comprising generating the plurality of performance metrics based on the plurality of valid software kernels.

24. An apparatus for kernel selection, the apparatus comprising:
means for inputting a plurality of valid software kernels to a trained machine learning (ML) model engine;
means for configuring the trained ML model engine to generate a first trained machine learning (ML) model based on the plurality of valid software kernels; and
means for using the first trained ML model to generate a machine learning (ML)-selected software kernel based on the plurality of valid software kernels.

25. The apparatus of claim 24, further comprising means for generating the plurality of valid software kernels based on one or more input parameters and a plurality of software kernels.

26. The apparatus of claim 25, wherein the one or more input parameters include one of the following: a plurality of tensors, an attribute of a mathematical operation or function, an attribute of a data or an attribute of a tensor descriptor.

27. The apparatus of claim 24, further comprising means for generating a second trained machine learning (ML) model.

28. The apparatus of claim 27, further comprising means for tuning the second trained ML model by using a training data from the training data repository to generate a tuned machine learning (ML) model.

29. A non-transitory computer-readable medium storing computer executable code, operable on a device comprising at least one processor and at least one memory coupled to the at least one processor, wherein the at least one processor is configured to implement kernel selection, the computer executable code comprising:
instructions for causing a computer to input a plurality of valid software kernels to a trained machine learning (ML) model engine;
instructions for causing the computer to configure the trained ML model engine to generate a first trained machine learning (ML) model based on the plurality of valid software kernels; and
instructions for causing the computer to use the first trained ML model to generate a machine learning (ML)-selected software kernel based on the plurality of valid software kernels.

30. The non-transitory computer-readable medium of claim 29, further comprising instructions for causing the computer to generate a second trained machine learning (ML) model and to tune the second trained ML model by using a training data to generate a tuned machine learning (ML) model.
